(19) United States
(12) Patent Application Publication
(10) Pub. No.: US 2007/0126936 A1
(43) Pub. Date: Jun. 7, 2007

(54) Digital broadcasting receiving apparatus and receiving method

(76) Inventors: Toru Fujihira, Yokohama (JP); Masao Ishiguro, Yokohama (JP); Takashi Tashiro, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/595,906

(22) Filed: Nov. 13, 2006

(30) Foreign Application Priority Data
May 13, 2005 (JP) 2005-140703

(51) Int. Cl. H04N 5/46

(52) U.S. Cl. 348/729

(57) ABSTRACT

According to the invention, in digital television broadcasting by a hierarchical transmission method, even if the receiving condition deteriorates and gives rise to any uncorrectable transmission error in streams, the deterioration of the quality of video and audio signals can be restrained to the minimum. The digital broadcasting receiving apparatus, after separating transmission streams of a plurality of levels into video and audio basic streams, subdivides the data of each stream and detects any error. Data which have been normally decoded are selected according to the relative priority of a designated level macro-block by macro-block or slice by slice for video data and frame by frame for audio data, and video and audio signals are thereby generated. Boundary parts of data of different levels are smoothed.

### BACKGROUND OF THE INVENTION

1. Field of the Invention

The present invention relates to a digital broadcasting receiving apparatus and a digital broadcasting receiving method which allows appropriate reception of digital broadcasts transmitted by a hierarchical transmission method.

2. Description of the Related Art

In recent years, television broadcasting has been increasingly digitized. In Japan, digital broadcasting via communication satellites was started in 1996, that via broadcasting satellites, in 2000, and terrestrial digital broadcasting, in 2003. These services are realized mainly by the MPEG system or digital modulation technique, which are techniques to compressively encode moving pictures. By transmitting information in a digitized form, broadcasts are enabled to be transmitted in higher quality over multiple channels. At the same time, in digital broadcasting, when the wave receiving condition falls below a certain level, the quality becomes far inferior to analog broadcasting. Especially in terrestrial digital broadcasting, it is required to strengthen resistance to multi-path obstruction of electric waves and to make possible mobile reception, and these requirements pose major challenges. In view of these problems, the band segment transmission orthogonal frequency division multiplexing (BST-OFDM) system is adopted, and transmission of a plurality of levels different in resistance to deterioration are transmitted by using a different transmission parameter for each group of OFDM segments, into which the transmission band is subdivided.

When broadcasts of the same content are transmitted at a plurality of levels, a receiver capable of receiving a plurality of levels can select the appropriate level for the receiving condition and reproduce the signals of that level. When the receiving condition is satisfactory at every level, the level at which image reproduction of high quality is expected (hereinafter referred to as level A) is selected. If the receiving condition deteriorates to make normal reproduction impossible at level A, level B at which image reproduction of high quality next to level A is selected. Further, if the receiving condition deteriorates to make normal reproduction impossible at level B, level C at which image reproduction of high quality next to level B is selected. By providing the receiver with such a function, its error-resistance can be strengthened. Examples include a mobile communication apparatus disclosed in Japanese Patent Laid-Open No. 2002-369254.

### SUMMARY OF THE INVENTION

In an MPEG system stream of digital broadcasting, the basic video and audio streams are multiplexed. Even if the receiving condition deteriorates and gives rise to any error in the system stream data, both the video and the audio are not necessarily deteriorated, and one of the basic streams may remain unaffected. Further in the structure of the video basic stream, encoding of each frame divided into a plurality of units known as slices enables, even if there is any error in stream data, the influence of the error to be restricted within a specific slice. Further, within each slice, each of subunits known as macro-blocks is encoded separately from others and, until any error occurs within the slice, no macro-block is affected by any error. Therefore, even if the receiving condition deteriorates and gives rise to any error in the system stream data of the video, if the error is relatively insignificant, only a part within the frame may be affected, leaving other parts capable of being normally reproduced.

According to the related art described in Japanese Patent Laid-Open No. 2002-369254 cited above, the stream data of the high-quality level determined to be abnormal are wholly discarded and replaced with stream data of a level inferior in quality. This results in an inconvenience that the user cannot view or listen to even the video or audio parts unaffected by the data error due to reception trouble. Although the cited patent application does not state the data unit on the basis of which the level selection is performed, the circuit configuration described therein evaluates the quality at the stage of the received data, namely before separation into video and audio, moreover before decoding. Therefore, it is impossible to select video and audio independent of each other, and difficult to select any level in units of data smaller than the frame.

An object of the present invention is to provide, in view of the problems noted above, a digital broadcasting receiving apparatus and a digital broadcasting receiving method which make possible, even if the receiving condition deteriorates and gives rise to an error in stream data, selection and reproduction of video and audio of the highest possible quality.

In order to solve the problems noted above, a digital broadcasting receiving apparatus according to the invention is provided with a separator which separates video and audio streams of each level; a video decoder which decodes the video streams; an audio decoder which decodes the audio streams; a video processor which generates video signals by dividing the decoded video data into the size of a frame or smaller and selecting the divided video data according to the relative priority of a designated level; and an audio processor which generates audio signals by dividing the decoded audio data into the size of a frame or smaller and selecting the divided audio data according to the relative priority of a designated level. The video processor, regarding video data which failed to be normally decoded by the video decoder, selects matching video data at the level next in relative priority, and the audio processor, regarding audio data which failed to be normally decoded by the audio decoder, selects matching audio data at the level next in relative priority.

It is preferable for the video processor to divide the video data into macro-blocks or slices and selects data there from.

It is preferable, when selecting video data from another level, to so convert the video data to be selected as to match the format of the video signals to be generated or to smooth the boundary parts of video data of adjoining different levels.

By a digital broadcasting receiving method according to the invention, received transmission streams are demodulated, video and audio streams of each level are separated from the demodulated transmission streams, and the video streams and the audio streams are decoded. The decoded video data are divided into the size of a frame or smaller, the divided video data are selected according to the relative priority of a designated level and, regarding video data which failed to be normally decoded, matching video data are selected at the level next in relative priority to generate video signals. The decoded audio data divided into the size of a frame or smaller, the divided audio data are selected according to the relative priority of a designated level and, regarding audio data which failed to be normally decoded, matching audio data are selected at the level next in relative priority to generate audio signals.

According to the present invention, even if the receiving condition of a digital broadcasting deteriorates, the deterioration of the quality of video and audio signals viewed or listened to can be restrained to the minimum.

### BRIEF DESCRIPTION OF THE DRAWINGS

Exemplary embodiments of the present invention will be described in detail based on the following figures, wherein:

FIG. 1 is a block diagram showing the configuration of a digital broadcasting receiving apparatus, which is a preferred embodiment of the present invention;

FIG. 2 shows the transmission spectrum of the BST-OFDM system in terrestrial digital broadcasting;

FIG. 3 shows the characteristics of different levels in hierarchical transmission;

FIG. 4 shows an example of configuration of an MPEG transmission stream;

FIG. 5 is a flow chart of one example of video processing by a digital broadcasting receiving method according to the invention;

FIG. 6 is a flow chart of one example of audio processing by the digital broadcasting receiving method according to the invention;

FIG. 7 is a block diagram showing the configuration of a digital broadcasting receiving apparatus, which is another preferred embodiment of the invention;

FIG. 8 illustrates a method by which the video and audio basic streams of different levels are separated from an MPEG transmission stream; and

FIGS. 9 schematically shows selective synthesis by a video synthesizer and scaling by a scaler.

### DETAILED DESCRIPTION OF THE EMBODIMENTS

Preferred embodiments of the present invention will be described with reference to the accompanying drawings. Although the digital broadcasting receiving apparatuses described above are intended for reception of terrestrial digital television broadcasts, the invention is not limited to such receiving apparatuses, but can be applied to any receiving apparatuses for receiving signals of a hierarchical transmission system.

Before describing the operation of the digital broadcasting receiving apparatus of this embodiment, the format of transmission signals in terrestrial digital television broadcasting will be briefly described.

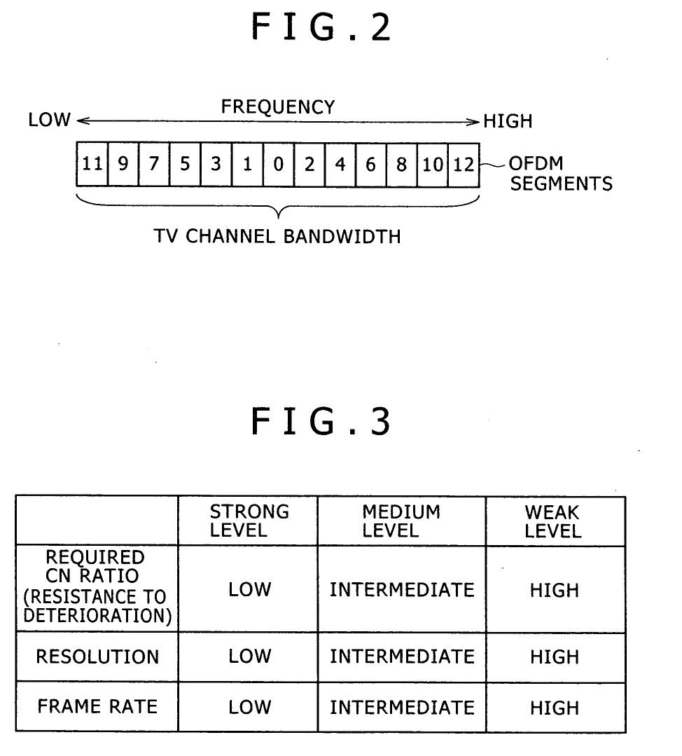

FIG. 2 shows the transmission spectrum of the BST-OFDM system in terrestrial digital broadcasting. The 6-MHz bandwidth of a TV channel is split into 13 OFDM segments, and is subject to frequency interleaving with segment 0 at the center. These OFDM segments are divided into a maximum of three groups and hierarchical transmission is carried out. Each level is configured of a transmission parameter, differing from one level to another, and one or more OFDM, and the levels are referred to as the strong level, the medium level and the weak level in the ascending order of the required CN ratio. Where there are two levels, they are referred to as the strong level and the weak level, and where there is only one level, it is referred to as the weak level. Three types of transmission parameters are available including that for stationary reception, that for mobile reception and that for reception by portable terminal.

FIG. 3 shows the characteristics of different levels in the hierarchy in terms of comparison among the levels with respect to the parameters in the table. The strong level is the lowest in required CN ratio (the highest in resistance to deterioration), but is set to be the lowest in both resolution and frame rate because the transmitted information rate is limited. Conversely, the weak level is the highest in required CN ratio (the lowest in resistance to deterioration), but both the resolution and the frame rate can be set highest. The medium level has intermediate characteristics between the strong level and the weak level. The hierarchical transmission at these levels makes possible strengthening of the resistance to deterioration and reception at the mobile terminal. Especially for the portable terminal, partial reception service by which simplified moving pictures of the H.264 standard is transmitted by using only the central OFDM segment (segment 0) at the strong level is made available to realize stable reception at a low required CN ratio.

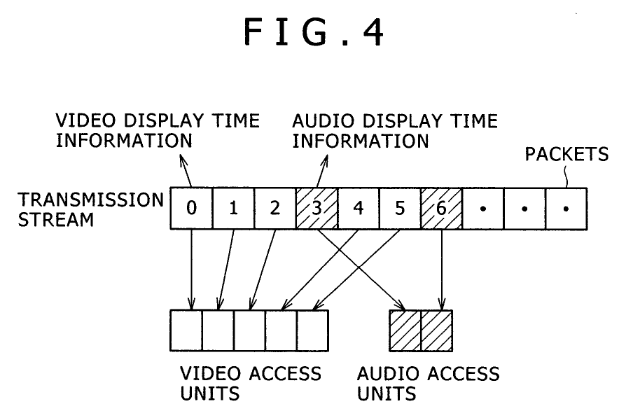

FIG. 4 shows an example of configuration of an MPEG transmission stream. An MPEG transmission stream is a transport stream provided, where terrestrial digital television broadcasting is concerned, by the MPEG 2 system standard (ISO/IEC 13818-1). An MPEG transmission stream is a system stream formed by multiplexing the basic video and audio streams, and is structured in a packet form to be suitable for transmission. Packets 0, 1, 2, 4 and 5 contain a basic stream constituting video access units. Packets 3 and 6 contain a basic stream constituting audio access units. The access units in this context mean basic stream data required for decoding video or audio frames. The leading packet of an access unit contains information on the time to display the frame to be decoded from the access unit.

### Embodiment 1

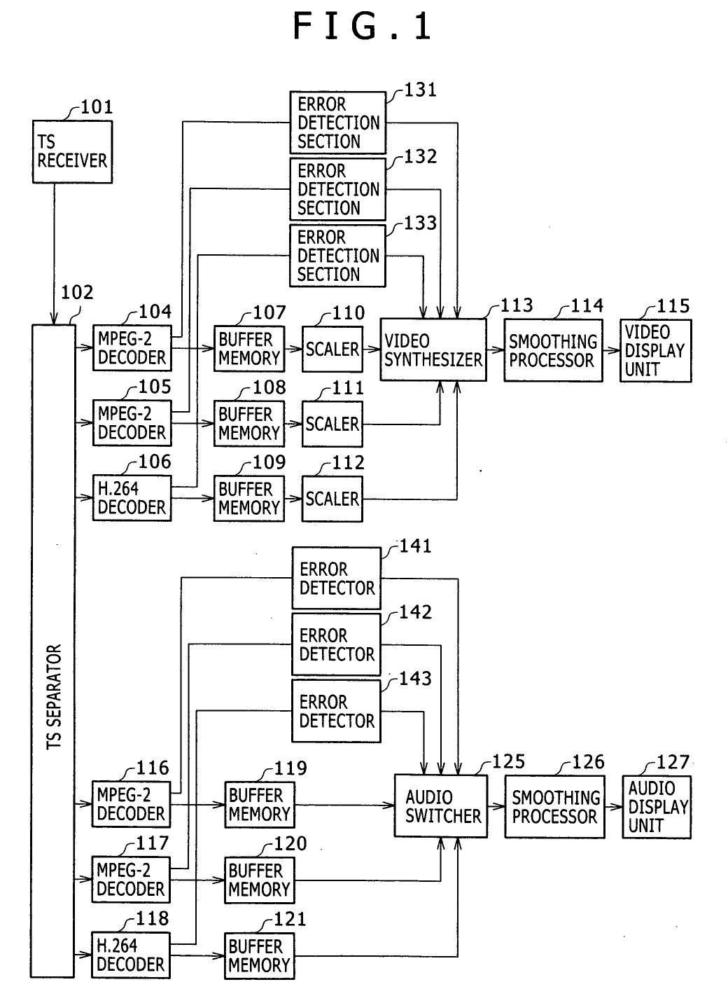

FIG. 1 is a block diagram showing the configuration of a digital broadcasting receiving apparatus, which is a preferred embodiment of the invention. The signal input unit has a transport stream (TS) receiver 101 and a TS separator 102. The video signal line has three decoders (including MPEG-2 decoders 104 and 105 and an H. 264 decoder 106), buffer memories 107 through 109, scalers 110 through 112, error detectors 131 through 133, a video synthesizer 113, a smoothing processor 114 and a video display unit 115. The audio signal line has three AAC decoders 116 through 118, buffer memories 119 through 121, error detectors 141 through 143, an audio switcher 125, a smoothing processor 126 and an audio display unit 127. The video display unit 115 and the audio display unit 127 may be either built into this receiving apparatus or connected externally.

The operation of the digital broadcasting receiving apparatus of this embodiment will be described below in due sequence. The TS receiver 101 receives the digital television broadcasting wave, subjects it to OFDM demodulation and error correction, and outputs the MPEG transmission stream of each level to the TS separator 102. The TS separator 102 separates video and audio basic streams from the MPEG transmission stream of each level obtained by the TS receiver 101. For the video basic streams here, the MPEG-2 standard (ITU-T H.262|ISO/IEC 13818-2) is used at the weak and medium levels, and the H.264 standard (ITU-T H.264|ISO/IEC 14496-10), at the strong level. For the audio basic streams, the MEG-2AAC standard (ISO/IEC13818-7) is used at every level.

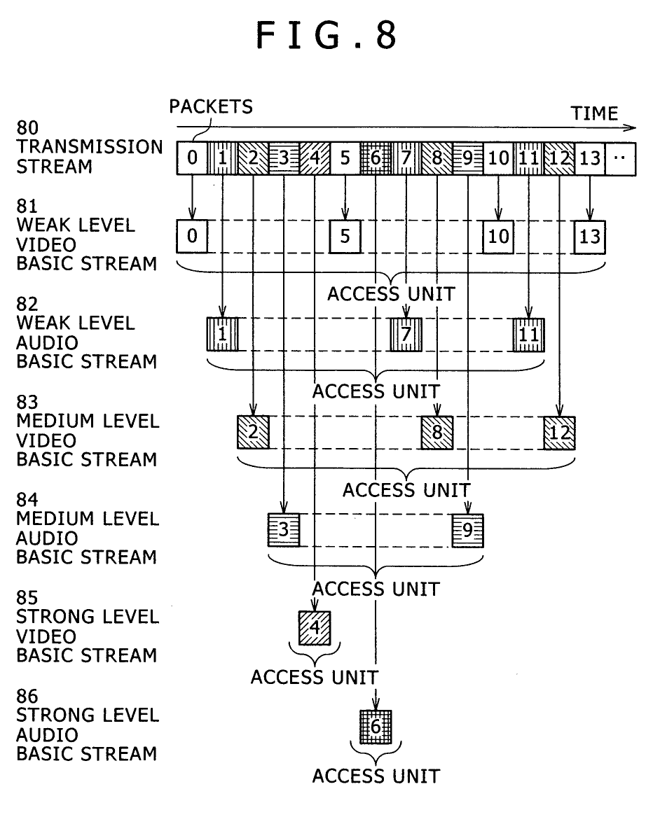

FIG. 8 illustrates a method by which the video and audio basic streams of different levels are separated from an MPEG transmission stream 80 by the TS separator 102. For instance from a weak level video basic stream 81, packets 0, 5, 10 and 13 are extracted to form an access unit. From a weak level audio basic stream 82, packets 1, 7 and 11 are extracted to form an access unit.

The video basic streams of different levels are outputted to the MPEG-2 decoders 104 and 105 and the H.264 decoder 106. The audio basic streams of different levels are outputted to the AAC decoders 116, 117 and 118. Incidentally, the formats of the video and audio basic streams are not limited to the aforementioned standards, but the use of other appropriate standards would entail no problem. In that case, decoders matching those other standards can be used as the decoders of different levels.

First will be described the processing of video signals. The MPEG-2 decoders 104 and 105 and the H.264 decoder 106 respectively decode the video basic streams of the weak, medium and strong levels, and stores the decoded frames into the buffer memories 107 through 109. Here, the size of the decoded frame and the frequency are supposed to differ from level to level. The error detectors 131 through 133 detect errors in the video basic streams of the weak, medium and strong levels, respectively. If there is any undecodable part in a frame, the detector outputs to the video synthesizer 113 the display time information on that frame and the positional information on that undecodable part in the frame. The scalers 110 through 112 so convert (scale) the frames of the weak, medium and strong levels respectively stored in the buffer memories 107 through 109 as to match the size and format of the output frame. This can be accomplished by a known scaling technique, such as linear interpolation. The video synthesizer 113, on the basis of error information received from the error detectors 131 through 133, selects scaled frame data of the different levels frame by frame, slice by slice or macro-block by macro-block, and synthesizes them. The order of precedence among the levels in this processing is prescribed to be from the weak toward the strong level.

This embodiment of the invention is so configured that the received streams are separated into video and audio basic streams and, after the separated streams are decoded, their quality (in terms of errors) is evaluated according to the result of decoding. Therefore, it is possible to finely divide the data size, which is the unit of quality evaluation. As a result, as will be described afterwards, audio signals can be processed frame by frame.

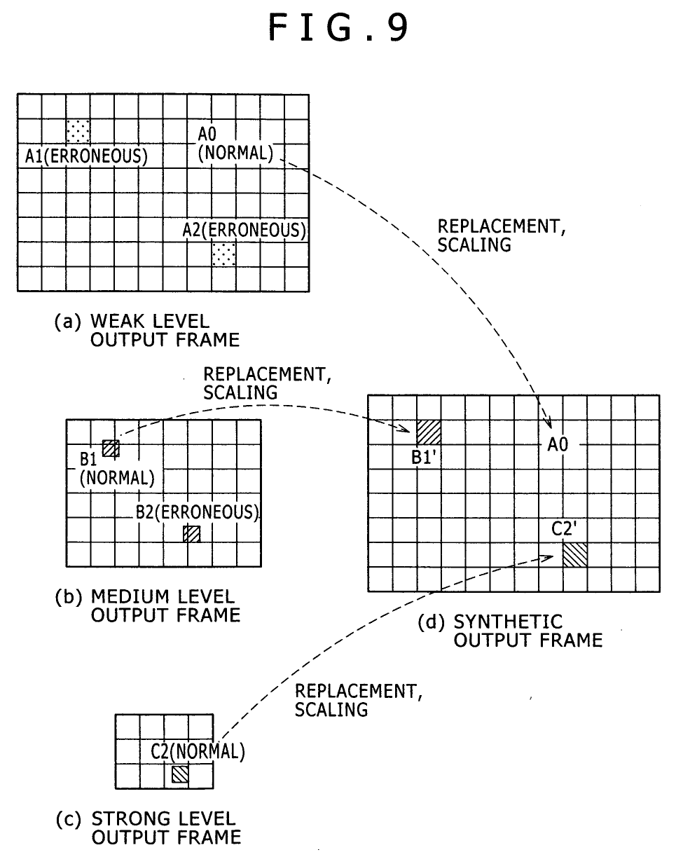

FIGS. 9 schematically show selective synthesis by the video synthesizer 113 and scaling by the scalers 110 through 112. FIG. 9(a) shows a weak level frame; FIG. 9(b), a medium level frame; FIG. 9(c), a strong level frame; and FIG. 9(d), asynthetic frame formed by synthesizing these sets of data. In the weak level frame (a), which is given the top priority, macro-blocks (MBs) denoted by A1 and A2 are supposed to be undecodable (erroneous MBs), and another MB denoted by A0 is supposed to be normal. These erroneous MBs (A1 and A2) are replaced with the corresponding parts B1 and B2 of the medium level frame (b). Then B1 is normal, but B2 cannot be used as it overlaps an erroneous MB. Therefore, it is further replaced with the corresponding part C2 of the strong level frame (c). In this processing, as the frames at different levels are not equal in size. Scaling (B1→B1′ and C2→C2′) is performed to match them with the size format of the synthetic frame (d).

In this embodiment, signals of the same image (in pattern and colors) are supplied to the frame of every level. If streams of different pattern and colors are supplied to the frames of different frames, patterns and colors different from the surroundings will be displayed in the parts denoted by B1′ and C2′ in the synthetic frame of FIG. 9(d) to make it known that those parts have been replaced with data of different levels.

The smoothing processor 114, when data of different levels have been synthesized in a frame, smoothes the boundary parts thereof. For this smoothing, a nonlinear filter having a low-pass characteristic, such as a linear low-pass filter or an order statistic filter, is used. The display unit 115 outputs in accordance with the display time information the frame generated by the video synthesizer 113 and the smoothing processor 114.

Next will be described the processing of audio signals. The AAC decoders 116 through 118 respectively decode the audio basic streams of the weak, medium and strong levels respectively decode the video basic streams of the weak, medium and strong levels, and stores the decoded frame into the buffer memories 119 through 121. The error detectors 141 through 143 detect errors in the audio basic streams of the weak, medium and strong levels, respectively. If there is any undecodable part in a frame, the detector outputs to the audio switcher 125 the display time information on that frame. The audio switcher 125, on the basis of error information received from the error detectors 141 through 143, selects and switches scaled frame data of the different levels frame by frame. The smoothing processor 126, when having switched data differing between frames, smoothes the boundary parts thereof. The audio display unit 127 outputs in accordance with the display time information the frames generated by the audio switcher 125 and the smoothing processor 126.

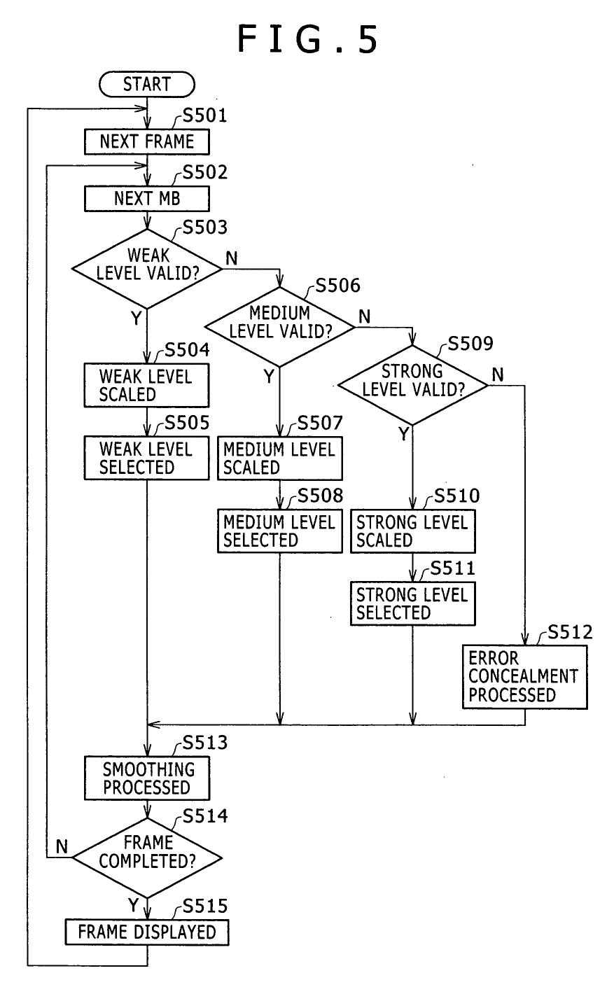

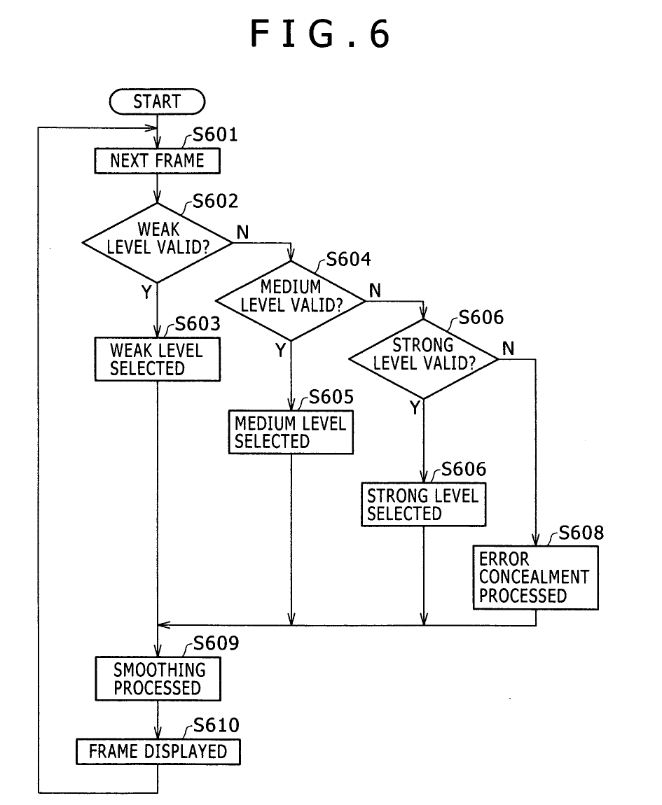

FIG. 5 is a flow chart of one example of video processing by a digital broadcasting receiving method according to the invention. With reference to this chart, a case of synthesizing video data macro-block by macro-block will be described with main focus on the operations of the video synthesizer 113.

The video synthesizer 113, on the basis of the display time information from the MPEG-2 decoders 104 and 105 and an H. 264 decoder 106, determines the frame to be displayed next (S501). The frame to be displayed next is the frame having the closest display time to the current time. The processing is then carried out on each of the macro-blocks (MBs) constituting the frame (S502).

First, it is determined on the basis of the data of the display time information from the MPEG-2 decoder 104 the error position information from the error detector 131 whether or not the data of the weak level in the current macro-block are valid (S503). If the data are found valid, they are scaled by the scaler 110 (S504), and selected as the data of the pertinent macro-block (S505).

If at S503 the data of the weak level are found invalid, it is determined on the basis of the display time information from the MPEG-2 decoder 105 and the error position information from the error detector 132, whether or not the data of the medium level in the current macro-block are valid (S506). If the data are found valid, they are scaled (S507), and selected as the data of the pertinent macro-block (S508).

If at S506 the data of the medium level are found invalid, it is determined on the basis of the display time information from the MPEG-2 decoder 106 and the error position information from the error detector 133, whether or not the data of the strong level in the current macro-block are valid (S509). If the data are found valid, they are scaled (S510), and selected as the data of the pertinent macro-block (S511).

If at S509 the data of the strong level are found invalid, error concealment processing is performed (S512). In the error concealment processing, for instance macro-block data in the same position in the preceding frame are used again.

When the data of the pertinent macro-block are selected, the boundary part thereof with the adjoining macro-block is smoothed as required (S513). For the smoothing, when the level of the adjoining macro-block is different from that of the pertinent macro-block, smoothing filter processing is performed for instance.

It is determined whether or not the processing of the pertinent frame has been completed (S514) and, if not, the processing returns to S502 to process the next macro-block. In this way, the processing of steps from S503 through S513 is repeated until all the data in the pertinent frame are selected. After the whole data in the frame have been determined, the pertinent frame is displayed in accordance with the display time information (S515). Upon completion of the pertinent frame, the processing returns to S501 to process the next frame.

By the operations described above, error-free data are selected macro-block by macro-block from the video frames in the prescribed order of precedence among the weak, medium and strong levels in that order, and it is thereby made possible to generate video data of high quality. By smoothing boundary parts of macro-blocks having data of different levels, block-shaped distortions can be prevented from occurring in a frame.

FIG. 6 is a flow chart of one example of audio processing by the digital broadcasting receiving method according to the invention. With reference to this chart, a case of switching audio data will be described with main focus on the operations of the audio switcher 125.

The audio switcher 125, on the basis of the display time information from the AAC decoders 116, 117 and 118, determines the frame to be displayed next (S601). The frame to be displayed next is the frame having the closest display time to the current time.

First it is determined, on the basis of the display time information from the AAC decoder 116 and erroneous frame information from the error detector 141, whether or not the data of the weak level in the current frame are valid (S602). If the data are found valid, they are selected as the data of the pertinent frame (S603).

If at S602, the data of the weak level are found invalid, it is determined on the basis of the display time information from the AAC decoder 117 and erroneous frame information from the error detector 142, whether or not the data of the medium level in the pertinent frame are valid (S604). If the data are found valid, they are selected as the data of the pertinent frame (S605).

If at S604, the data of the medium level are found invalid, it is determined on the basis of the display time information from the AAC decoder 118 and erroneous frame information from the error detector 143, whether or not the data of the strong level in the pertinent frame are valid (S606). If the data are found valid, they are selected as the data of the pertinent frame (S607).

If at S606, the data of the strong level are found invalid, error concealment processing is performed (S608). In the error concealment processing, for instance such frame data as are smoothly continuous from the preceding frame and attenuate are generated.

After the data of the pertinent frame are selected, the frame boundary is smoothed as required (S609). For the smoothing, when the level of the adjoining frame is different from that of the pertinent frame, smoothing filter processing is performed for instance.

After the whole data in the frame have been determined, the pertinent frame is displayed in accordance with the display time information (S610). Upon completion of the pertinent frame, the processing returns to S601 to process the next frame.

By the operations described above, error-free data are selected frame by frame from the audio frames in the prescribed order of precedence among the weak, medium and strong levels in that order, and it is thereby made possible to generate audio data of high quality. By smoothing boundary parts of frames having data of different levels, noise due to discontinuity of data can be prevented from occurring.

As described above, the digital broadcasting receiving apparatus and the digital broadcasting receiving method of this embodiment make it possible to process Video data and audio data independent of each other, and to select and reproduce the level of the highest quality, unaffected by any transmission error, for each in subdivided units of data.

Although the quality is determined macro-block by macro-block for video data and frame by frame for audio data in the embodiment described above, these are not the only appropriate units, but sufficiently fine division of data into any other units would also be acceptable. The invention can also be expected to prove effective if, for instance, the slice level or the frame level, which is greater than the macro-block level in size, is used for video data.

In this embodiment, as many macro-blocks as have been determined invalid in video signal processing are replaced by data of another level. If the number of replaced macro-blocks in a frame is too large, boundary parts will become conspicuously discontinuous, resulting in deterioration in overall picture quality. In such a case, it is rather advisable to change the unit of data to be selected to a greater size, such as the frame or the slice. Therefore, it will be effective to add a control function to count the number of macro-blocks found in valid in a frame and, if that number surpasses a threshold, to change over the unit of data to be selected from the macro-block to the frame or the slice.

Whereas this embodiment is supposed to have three each of decoders, buffer memories and scalers matching the weak, medium and strong levels, respectively, each type of them has the same functions, and can be replaced with a common hardware unit used on a time division basis.

Although decoding is accomplished in parallel at all of the weak, medium and strong levels in this embodiment irrespective of the relative quality of reception at each level, it is also conceivable to decode only signals of the weak level, which is given the top priority, at normal times, and to switch over to decoding of signals of the medium level of the next priority, or signals of the strong level if necessary, it data of the weak level have been determined invalid. This provides the advantage of reducing power consumption.

### Embodiment 2

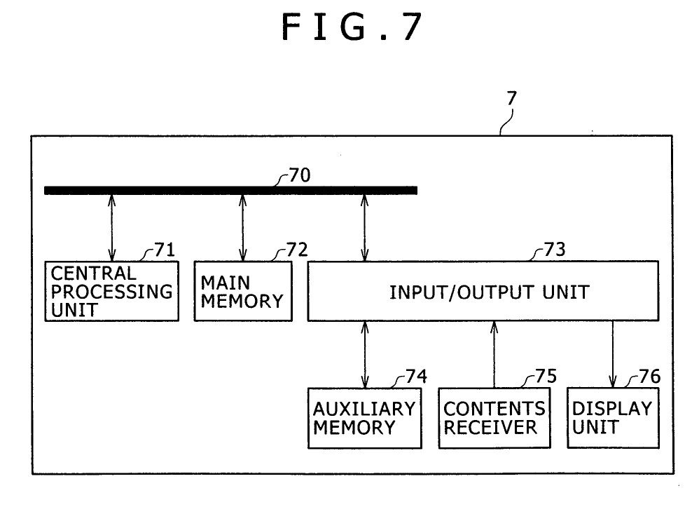

FIG. 7 is a block diagram showing the configuration of a digital broadcasting receiving apparatus, which is another preferred embodiment of the invention. The receiving apparatus according to the invention can as well be realized with software, and this embodiment is one example of such software.

A digital broadcasting receiving apparatus 7 connects a central processing unit 71, a main memory 72 and an input/output unit 73 to a system bus 70. The input/output unit 73 connects an auxiliary memory 74, a TS receiver 75 and a display unit 76. The display unit 76 may as well be connected outside this apparatus 7. The auxiliary memory 74 stores programs and data for processing by the central processing unit 71, transmission streams of different levels received by the TSI receiver 75, video and audio basic streams, and data of decoded frames and output frames. The main memory 72 consecutively stores programs read out of the auxiliary memory 74 and data being processed. The central processing unit 71 performs processing in accordance with a program in the main memory 72.

Under processing by the central processing unit 71, the transmission streams of digital television received by the TS receiver 75 are stored into the main memory 72. The central processing unit 71 consecutively separates video and audio basic streams of different levels from these transmission streams and stores them into the main memory 72. Also, the central processing unit 71 consecutively decodes these video and audio basic streams, and stores the decoded frames, the display time information and the error position information into the main memory 72. Further, the central processing unit 71, on the basis of the display time information and the error position information, selects, synthesizes, switches over, smoothes and otherwise processes the video and audio decoded frame, and displays the processed frames on the display unit 76. The particulars of the processing are the same as those shown above in FIG. 5 and FIG. 6. The central processing unit 71 sequentially performs these steps of processing on a time division basis.

The configuration described above enables the digital broadcasting receiving apparatus this embodiment to achieve the same advantages as the foregoing Embodiment 1.

Although both these embodiments were described with reference to their use in hierarchical transmission have three levels, the strong, medium and weak, in terrestrial digital television broadcasting by way of example, obviously the invention can be applied to hierarchical transmission having any other desired number of levels. Also, the order of precedence among the weak, medium and strong levels is in this sequence, but it can be differently designated according to the purpose of viewing and listening.

According to the invention, even if the receiving condition deteriorates and gives rise to any error in streams when receiving a digital broadcasting transmitted hierarchically at a plurality of levels as in terrestrial digital television broadcasting, the deterioration of the quality of video and audio signals viewed or listened to can be restrained to the minimum. As a result, the resistance to the deterioration of reception can be strengthened, making the invention applicable with particular effectiveness to mobile receivers or the like whose reception environment is more susceptible to fluctuations.

The receiving apparatus according to the invention is applicable not only to a television set having this apparatus built into it but also to an apparatus having a recording unit for recording received signals on a recording medium, such as a hard disk (HDD recorder).

What is claimed is:

1. A digital broadcasting receiving apparatus for receiving digital broadcasts transmitted in a hierarchical system comprising:
a receiver which demodulates received transmission streams;
a separator which separates video and audio streams of each level from the demodulated transmission streams;
a video decoder which decodes the video streams;
an audio decoder which decodes the audio streams;
a video processor which generates video signals by dividing the decoded video data into the size of a frame or smaller and selecting the divided video data according to the relative priority of a designated level; and
an audio processor which generates audio signals by dividing the decoded audio data into the size of a frame or smaller and selecting the divided audio data according to the relative priority of a designated level, wherein:
the video processor, regarding video data which failed to be normally decoded by the video decoder, selects matching video data at the level next in relative priority; and
the audio processor, regarding audio data which failed to be normally decoded by the audio decoder, selects matching audio data at the level next in relative priority.

2. The digital broadcasting receiving apparatus according to claim 1, wherein:
the received transmission streams include streams of a weak level, a medium level and a strong level in the descending order of quality; and
the video processor and the audio processor selects the video data and the audio data in the descending order of quality.

3. The digital broadcasting receiving apparatus according to claim 1, wherein:
the video processor divides the video data into macro-blocks and selects data therefrom.

4. The digital broadcasting receiving apparatus according to claim 1, wherein:
the video processor divides the video data into slices and selects data therefrom.

5. The digital broadcasting receiving apparatus according to claim 3, wherein:
the video processor switches over, according to the frequency of video data in the macro-block unit which failed to be normally decoded by the video decoder, the unit of the video data to be selected into the slice unit or the frame unit.

6. The digital broadcasting receiving apparatus according to claim 1, wherein:
the video processor, when selecting video data from another level, so converts the video data to be selected as to match the format of the video signals to be generated.

7. The digital broadcasting receiving apparatus according to claim 1, wherein:
the video processor, when selecting video data from another level, smoothes the boundary parts of video data of adjoining different levels.

8. The digital broadcasting receiving apparatus according to claim 1, wherein:
the audio processor, when selecting audio data from another level, smoothes the boundary parts of audio data of adjoining different levels.

9. The digital broadcasting receiving apparatus according to claim 1, wherein:
the video decoder and the audio decoder executes decoding of video streams and audio streams of the designated high-priority level and, if the decoding fails to be normally executed, executes decoding of the video stream or the audio stream of the next high-priority level.

10. The digital broadcasting receiving apparatus according to claim 1, comprising:
an arithmetic processor which causes the operations of the separator, the video decoder, the audio decoder, the video processor and the audio processor to be executed with software; and
a memory which stores the software for the arithmetic processing and the video and audio data.

11. A digital broadcasting receiving method for receiving digital broadcasts transmitted in a hierarchical system, wherein:
received transmission streams are demodulated;
video and audio streams of each level are separated from the demodulated transmission streams;
the video streams and the audio streams are decoded;
the decoded video data are divided into the size of a frame or smaller, the divided video data are selected according to the relative priority of a designated level and, regarding video data which failed to be normally decoded, matching video data are selected at the level next in relative priority to generate video signals; and
the decoded audio data are divided into the size of a frame or smaller, the divided audio data are selected according to the relative priority of a designated level and, regarding audio data which failed to be normally decoded, matching audio data are selected at the level next in relative priority to generate audio signals.

12. The digital broadcasting receiving method according to claim 11, wherein:
the received transmission streams include streams of a weak level, a medium level and a strong level in the descending order of quality; and
the video data and the audio data are selected in the descending order of quality.

13. The digital broadcasting receiving method according to claim 11, wherein:
the video data are divided into macro-blocks and data are selected therefrom.

14. The digital broadcasting receiving method according to claim 11, wherein:
the video data are divided into slices and data are selected therefrom.

15. The digital broadcasting receiving method according to claim 13, wherein:
the unit of the video data to be selected is switched over into the slice unit or the frame unit according to the frequency of video data in the macro-block unit which failed to be normally decoded.

16. The digital broadcasting receiving method according to claim 11, wherein:
when selecting video data from another level, the video data to be selected are so converted as to match the format of the video signals to be generated.

17. The digital broadcasting receiving method according to claim 11, wherein:
when selecting video data from another level, the boundary parts of video data of adjoining different levels are smoothed.

18. The digital broadcasting receiving method according to claim 11, wherein:
when selecting audio data from another level, the boundary parts of audio data of adjoining different levels are smoothed.

19. The digital broadcasting receiving method according to claim 11, wherein:
decoding of video streams and audio streams of the designated high-priority level is executed and, if the decoding fails to be normally executed, decoding of the video stream or the audio stream of the next high-priority level is executed.

20. A digital broadcasting receiving apparatus for receiving digital broadcasts transmitted in a hierarchical system comprising:
a receiver which demodulates received transmission streams;
a separator which separates video streams of each level from the transmission streams;
a video decoder which decodes the video streams; and
a video processor which generates video signals by dividing the decoded video data into macro-blocks and selecting the divided video data according to the relative priority of a designated level, wherein:
the video processor, regarding video data which failed to be normally decoded by the video decoder, selects matching video data at the level next in relative priority; and
if the video stream of the first level given the top priority in the transmission streams contain any undecodable macro-block and the video stream of the second level next in priority supplies the receiver with a transmission stream configured of an image of a different pattern from the first level, the video processor replaces the video part of the undecodable macro-block of the first level with the image of the different pattern of the second level.
